(19) United States
(12) Patent Application Publication
(10) Pub. No.: US 2025/0317994 A1
(43) Pub. Date: Oct. 9, 2025

(54) EVENT-BASED INITIATION OF A MORE DATA MODE FOR A WIRELESS PERSONAL AREA NETWORK LOW ENERGY CONNECTION

(71) Applicant: QUALCOMM Incorporated, San Diego, CA (US)

(72) Inventors: Xie YINGCHAO, Shanghai (CN); Jie ZENG, Shanghai (CN); Runyuan LIU, Shanghai (CN); Fan WU, Shanghai (CN)

(21) Appl. No.: 18/872,568

(22) PCT Filed: Aug. 31, 2022
(86) PCT No.: PCT/CN2022/116080

§ 371 Date: Dec. 6, 2024

(51) Int. Cl. H04W 76/10; H04W 74/0816; H04W 84/10

(52) U.S. Cl. CPC H04W 76/10; H04W 74/0816; H04W 84/10

(57) ABSTRACT

Various aspects of the present disclosure generally relate to wireless communication. In some aspects, a wireless communication device may establish a wireless personal area network (WPAN) low energy (LE) connection with a receiving device, the WPAN LE connection being associated with a first number of transmission occasions for each transmission interval. The wireless communication device may identify an event associated with one or more of: a number of communications that satisfies a quantity threshold, or one or more communications having a latency requirement that satisfies a latency threshold. The wireless communication device may transmit, to the receiving device and based at least in part on identifying the event, an indication to communicate using a more data (MD) mode, the MD mode being associated with a second number of transmission occasions for each transmission interval, the second number being greater than the first number. Numerous other aspects are described.

### FIELD OF THE DISCLOSURE

Aspects of the present disclosure generally relate to wireless communication and to techniques and apparatuses for event-based initiation of a more data mode for a wireless personal area network low energy connection.

### BACKGROUND

A wireless personal area network (WPAN) is a short-range wireless network typically established by a user to interconnect various personal devices, sensors, and/or appliances located within a certain distance or area of the user. For example, WPANs based on communication protocols such as a Bluetooth® (BT) protocol, a Bluetooth® Low Energy protocol, or a Zigbee® protocol may provide wireless connectivity to peripheral devices within a specific distance (such as 5 meters, 10 meter, 20 meters, 100 meters, etc.) of the user.

Bluetooth is a short-range wireless communication protocol that supports a WPAN between a central device (such as a host device) and at least one peripheral device (such as a client device). Power consumption associated with Bluetooth communications may render Bluetooth impractical in certain applications.

To address the power consumption issue associated with Bluetooth, Bluetooth® Low Energy (BLE) (also referred to herein as WPAN LE) was developed and adopted in various applications in which data transfers are relatively infrequent. Specifically, BLE exploits the infrequent transfer of data by using a low duty cycle operation, and placing one or both the central device and the peripheral device(s) into a sleep mode between data transmissions, thereby conserving power. Example applications that use BLE include battery-operated sensors and actuators in various medical, industrial, consumer, and fitness applications. BLE may also be used to connect devices such as BLE enabled smart phones, tablets, and laptops. While traditional Bluetooth and BLE offer certain advantages, there exists a need for further improvements in Bluetooth and BLE technology. For example, traditional Bluetooth and BLE have limited range, have limited data capacity throughput, and are susceptible to interference from other devices communicating in the same frequency band (such as Wi-Fi communications).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description presented later.

Some aspects described herein relate to a method of wireless communication performed by a wireless communication device. The method may include establishing a wireless personal area network (WPAN) low energy (LE) connection with a receiving device, the WPAN LE connection being associated with a first number of transmission occasions for each transmission interval. The method may include identifying an event associated with one or more of, a number of communications that satisfies a quantity threshold, or one or more communications having a latency requirement that satisfies a latency threshold. The method may include transmitting, to the receiving device and based at least in part on identifying the event, an indication to communicate using a more data (MD) mode, the MD mode being associated with a second number of transmission occasions for each transmission interval, the second number being greater than the first number.

Some aspects described herein relate to a wireless communication device for wireless communication. The wireless communication device may include a memory and one or more processors coupled to the memory. The one or more processors may be configured to establish a WPAN LE connection with a receiving device, the WPAN LE connection being associated with a first number of transmission occasions for each transmission interval. The one or more processors may be configured to identify an event associated with one or more of a number of communications that satisfies a quantity threshold, or one or more communications having a latency requirement that satisfies a latency threshold. The one or more processors may be configured to transmit, to the receiving device and based at least in part on identifying the event, an indication to communicate using a MD mode, the MD mode being associated with a second number of transmission occasions for each transmission interval, the second number being greater than the first number.

Some aspects described herein relate to a non-transitory computer-readable medium that stores a set of instructions for wireless communication by a wireless communication device. The set of instructions, when executed by one or more processors of the wireless communication device, may cause the wireless communication device to establish a WPAN LE connection with a receiving device, the WPAN LE connection being associated with a first number of transmission occasions for each transmission interval. The set of instructions, when executed by one or more processors of the wireless communication device, may cause the wireless communication device to identify an event associated with one or more of a number of communications that satisfies a quantity threshold, or one or more communications having a latency requirement that satisfies a latency threshold. The set of instructions, when executed by one or more processors of the wireless communication device, may cause the wireless communication device to transmit, to the receiving device and based at least in part on identifying the event, an indication to communicate using a MD mode, the MD mode being associated with a second number of transmission occasions for each transmission interval, the second number being greater than the first number.

Some aspects described herein relate to an apparatus for wireless communication. The apparatus may include means for establishing a WPAN LE connection with a receiving device, the WPAN LE connection being associated with a first number of transmission occasions for each transmission interval. The apparatus may include means for identifying an event associated with one or more of, a number of communications that satisfies a quantity threshold, or one or more communications having a latency requirement that satisfies a latency threshold. The apparatus may include means for transmitting, to the receiving device and based at least in part on identifying the event, an indication to communicate using a MD mode, the MD mode being associated with a second number of transmission occasions for each transmission interval, the second number being greater than the first number.

Aspects generally include a method, apparatus, system, computer program product, non-transitory computer-readable medium, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a Wireless Personal Area Network (WPAN), in accordance with the present disclosure.

FIG. 2 is a diagram illustrating an example of a wireless communication device, in accordance with the present disclosure.

FIG. 3 is a diagram illustrating an example of a protocol stack, in accordance with the present disclosure.

FIG. 4 is a diagram illustrating an example transmission of a data packet from a wireless communication device to a peripheral device, in accordance with the present disclosure.

FIG. 5 is a diagram illustrating an example of a wireless communication device, in accordance with the present disclosure.

FIG. 6 is a diagram illustrating an example of communication via a WPAN low energy (LE) connection, in accordance with the present disclosure.

FIGS. 7-10 are diagrams illustrating examples associated with event-based initiation of a more data mode for a WPAN LE connection, in accordance with the present disclosure.

FIG. 11 is a diagram illustrating an example process associated with event-based initiation of a more data mode for a WPAN LE connection, in accordance with the present disclosure.

FIG. 12 is a diagram of an example apparatus for wireless communication, in accordance with the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

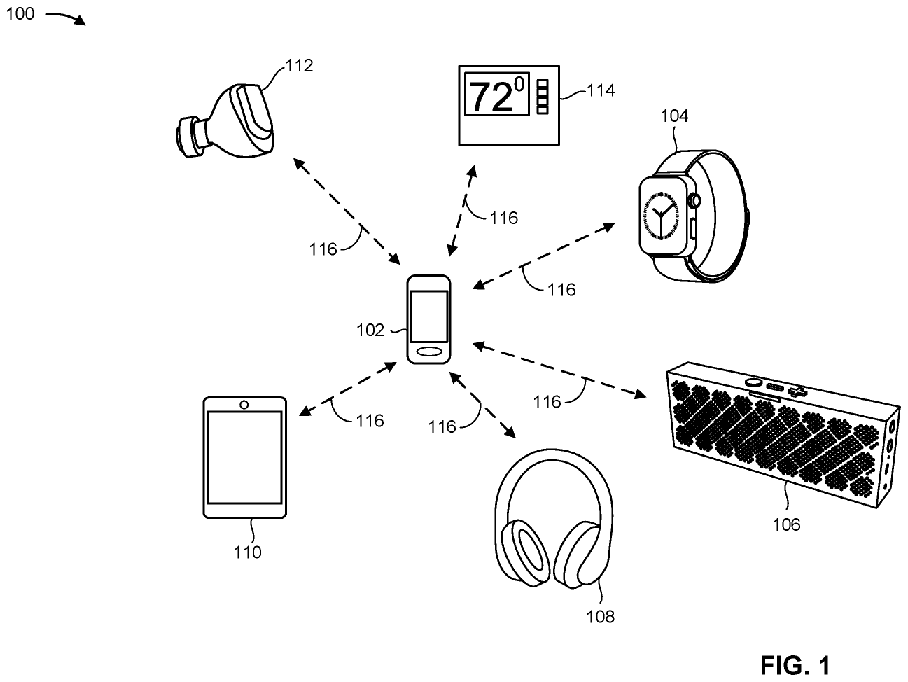

FIG. 1 is a diagram illustrating an example of a Wireless Personal Area Network (WPAN) 100, according to some implementations. Within the WPAN 100, a central device 102 may connect to and establish a BLE communication link 116 with one or more peripheral devices 104, 106, 108, 110, 112, 114 using a BLE protocol or a modified BLE protocol. The BLE protocol is part of the BT core specification and enables radio frequency communication operating within the globally accepted 2.4 GHZ Industrial, Scientific & Medical (ISM) band.

The central device 102 may include suitable logic, circuitry, interfaces, processors, and/or code that may be used to communicate with one or more peripheral devices 104, 106, 108, 110, 112, or 114 using the BLE protocol or the modified BLE protocol as described herein. The central device 102 may operate as an initiator to request establishment of a Link Layer (LL) connection with an intended peripheral device 104, 106, 108, 110, 112, or 114. A Link Manager may be used to control operations between a Bluetooth over IP (BToIP) application controller in the central device 102 and a BToIP application controller in each of the intended peripheral devices 104, 106, 108, 110, 112, and/or 114.

After a requested link layer connection is established, the central device 102 may become a host device, and the selected or intended peripheral device 104, 106, 108, 110, 112, or 114 may become paired with the central device 102 over the established link layer connection. As a host device, the central device 102 may be capable of supporting multiple link layer connections at a time with various peripheral devices 104, 106, 108, 110, 112, or 114 operating as client devices. Specifically, the central device 102 may manage various aspects of data packet communication in a link layer connection with one or more of the associated peripheral devices 104, 106, 108, 110, 112, or 114. For example, the central device 102 may determine an operation schedule in the link layer connection with one or more peripheral devices 104, 106, 108, 110, 112, or 114. The central device 102 may also initiate a link layer protocol data unit (PDU) exchange sequence over the link layer connection. Link layer connections may be configured to run periodic connection events in dedicated data channels. The exchange of link layer data PDU transmissions between the central device 102 and one or more of the peripheral devices 104, 106, 108, 110, 112, or 114 may take place within connection events.

In some implementations, the central device 102 may be configured to transmit the first link layer data PDU in each connection event to an intended peripheral device 104, 106, 108, 110, 112, or 114. In other implementations, the central device 102 may utilize a polling scheme to poll the intended peripheral device 104, 106, 108, 110, 112, or 114 for a link layer data PDU transmission during a connection event. The intended peripheral device 104, 106, 108, 110, 112, or 114 may transmit a link layer data PDU upon receipt of packet link layer data PDU from the central device 102. In some other implementations, a peripheral device 104, 106, 108, 110, 112, or 114 may transmit a link layer data PDU to the central device 102 without first receiving a link layer data PDU from the central device 102.

Examples of the central device 102 may include a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player, a camera, a game console, a tablet, a smart device, a wearable device (such as a smart watch, wireless headphones, etc.), a vehicle, an electric meter, a gas pump, a toaster, a thermostat, a hearing aid, a blood glucose on-body unit, an Internet-of-Things (IoT) device, or any other similarly functioning device.

Examples of the one or more peripheral devices 104, 106, 108, 110, 112, or 114 may include a cellular phone, a smart phone, a SIP phone, a STA, a laptop, a PC, a desktop computer, a PDA, a satellite radio, a global positioning system, a multimedia device, a video device, a digital audio player, a camera, a game console, a tablet, a smart device, a wearable device (such as a smart watch, wireless headphones, etc.), a vehicle, an electric meter, a gas pump, a toaster, a thermostat, a hearing aid, a blood glucose on-body unit, an IoT device, or any other similarly functioning device. Although the central device 102 is illustrated in communication with six peripheral devices 104, 106, 108, 110, 112, or 114 in the WPAN 100, the central device 102 may communicate with more or fewer than six peripheral devices within the WPAN 100 without departing from the scope of the present disclosure.

A device implementing the BT protocol, such as the central device 102, may operate according to one radio mode, such as basic rate (BR)/enhanced data rate (EDR), and a device implementing the BLE protocol may operation according to a BLE radio mode. In some aspects, the central device 102 may be configured with dual radio modes, and therefore may be able to operate according to the BR/EDR mode or the BLE mode, for example, based on the type of short-rage wireless communication in which the device may engage.

For example, the central device 102 may operate according to the BR/EDR mode for continuous streaming of data, for broadcast networks, for mesh networks, and/or for some other applications in which a relatively higher data rate may be more suitable. However, the device may operate according to the BLE mode for short burst data transmissions, such as for some other applications in which power conservation may be desirable and/or a relatively lower data rate may be acceptable. In other aspects, the central device 102 may operate according to one or more other radio modes, including proprietary radio mode(s). Examples of other radio modes may include high speed radio modes, low energy radio modes, isochronous radio modes, etc.

As indicated above, FIG. 1 is provided as an example. Other examples may differ from what is described with regard to FIG. 1.

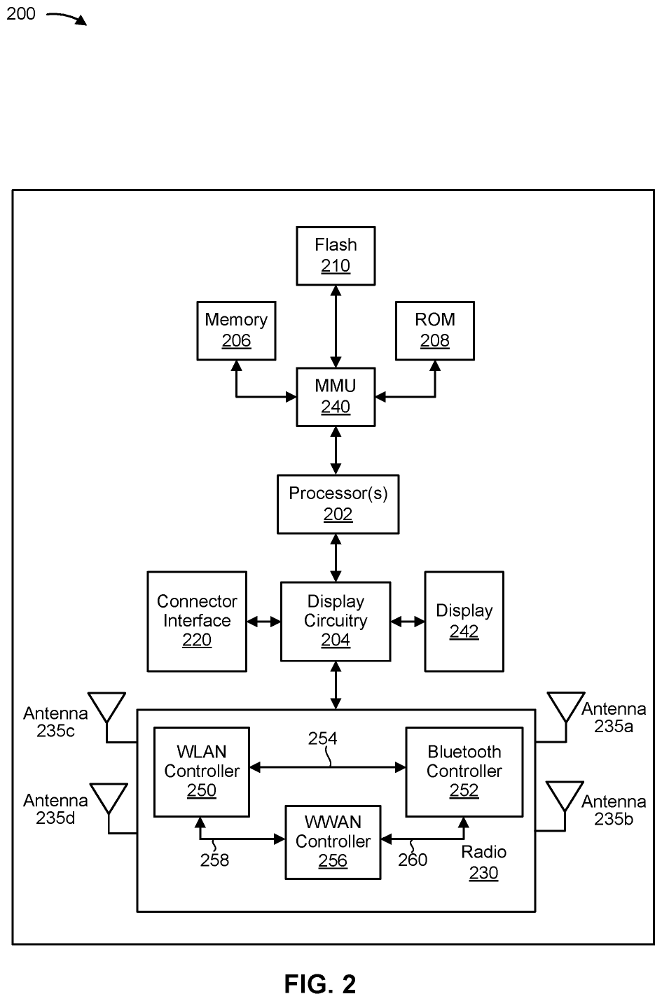

FIG. 2 is a diagram illustrating an example of a wireless communication device 200, in accordance with the present disclosure. In some instances, the wireless communication device 200 may be an example of the central device 102 of FIG. 1. In other instances, the wireless communication device 200 may be an example of one or more of the peripheral devices 104, 106, 108, 110, 112, or 114 of FIG. 1. In some aspects, the wireless communication device 200 may be a Bluetooth-enabled device (such as a BLE device).

As shown, the wireless communication device 200 may include a processing element, such as processor(s) 202, which may execute program instructions for the wireless communication device 200. The wireless communication device 200 may also include a display 242 that can perform graphics processing and present information to a user. The processor(s) 202 may also be coupled to memory management unit (MMU) 240, which may be configured to receive addresses from the processor(s) 202 and translate the addresses to address locations in memory such as memory 206, ROM 208, or Flash memory 210) and/or to address locations in other circuits or devices, such as the display circuitry 204, radio 230, connector interface 220, and/or display 242. The MMU 240 may also be configured to perform memory protection and page table translation or set up. In some aspects, the MMU 240 may be included as a portion of the processor(s) 202.

The processor(s) 202 may be coupled to other circuits of the wireless communication device 200. For example, the wireless communication device 200 may include various types of memory, a connector interface 220 through which the wireless communication device 200 can communicate with the computer system, and wireless communication subsystems that can transmit data to, and receive data from, other devices based on one or more wireless communication standards or protocols. For example, in some aspects, the wireless communication subsystems may include (but are not limited to) a wireless local-area network (WLAN) subsystem, a Bluetooth subsystem, or a cellular subsystem (such as a long-term evolution (LTE) or 5^{th} generation (5G) new radio (NR) subsystem). The wireless communication device 200 may include a plurality of antennas 235a. 235b, 235c, or 235d for performing wireless communication with, for example, wireless communication devices in a WPAN.

The wireless communication device 200 may be configured to implement part or all of the techniques described herein by executing program instructions stored on a memory medium (such as a non-transitory computer-readable memory medium) and/or through hardware or firmware operation. In other embodiments, the techniques described herein may be at least partially implemented by a programmable hardware element, such as a field programmable gate array (FPGA), and/or an application specific integrated circuit (ASIC).

In certain aspects, the radio 230 may include separate controllers configured to control communications for various respective radio access technology (RAT) protocols. For example, as shown in FIG. 2, radio 230 may include a WLAN controller 250 that manages WLAN communications, a Bluetooth controller 252 that manages Bluetooth and BLE communications, and a Wireless Wide Area Network (WWAN) controller 256 that manages WWAN communications. In certain aspects, the wireless communication device 200 may store and execute a WLAN software driver for controlling WLAN operations performed by the WLAN controller 250, a Bluetooth software driver for controlling Bluetooth operations performed by the Bluetooth controller 252, and/or a WWAN software driver for controlling WWAN operations performed by the WWAN controller 256.

In certain implementations, a first coexistence interface 254 (such as a wired interface) may be used for sending information between the WLAN controller 250 and the Bluetooth controller 252. In certain other implementations, a second coexistence interface 258 may be used for sending information between the WLAN controller 250 and the WWAN controller 256. In certain other implementations, a third coexistence interface 260 may be used for sending information between the Bluetooth controller 252 and the WWAN controller 256.

In some aspects, one or more of the WLAN controller 250, the Bluetooth controller 252, and/or the WWAN controller 256 may be implemented as hardware, software, firmware or some combination thereof.

In certain configurations, the WLAN controller 250 may be configured to communicate with a second device in a WPAN using a WLAN link using all of the antennas 235a, 235b, 235c, and 235d. In certain other configurations, the Bluetooth controller 252 may be configured to communicate with at least one second device in a WPAN using one or more of the antennas 235a, 235b, 235c, and 235d. In certain other configurations, the WWAN controller 256 may be configured to communicate with a second device in a WPAN using all of the antennas 235a, 235b, 235c, and 235d. The WLAN controller 250, the Bluetooth controller 252, and/or the WWAN controller 256 may be configured to adjust wakeup time interval and shutdown time for the device.

A short-range wireless communications protocol, such as BT, BLE, and/or BR/EDR, may include and/or may use one or more other communications protocols, for example, for establishing and maintaining communications links. Referring also to FIG. 1, the wireless communication device 200 may establish a communications link 116 with one or more peripheral devices, such as a wireless headset 112, according to at least one communications protocol for short-range wireless communications.

The communications link 116 may include a communications link that adheres to a protocol included and/or for use with BT, BLE, BR/EDR, etc. In one aspect, the communications link 116 may include an asynchronous connection-less (ACL) link. When operating as an ACL link, the communications link 116 may allow the central device 102 (e.g., a source device) to connect or “pair” with a peripheral device, such as the headset 112. The connection is asynchronous in that the two devices may not need to synchronize, time-wise, data communications between each other to permit communication of data packets via the communications link 116.

A Logical Link Control and Adaptation Protocol (L2CAP) may be used within a BT protocol stack (not shown in FIG. 2 for simplicity). An L2CAP connection may be established after an ACL link has been established. Reference to L2CAP in the present disclosure may be further applicable to enhanced L2CAP (EL2CAP), which may be an enhanced version of the L2CAP protocol that enables multiplexing of multiple logical data channels via a single radio connection.

In one aspect, the communications link 116 may include an Advanced Audio Distribution Profile (A2DP) link. An A2DP link provides a point-to-point link between a source device, such as the central device 102, and a sync device, such as the headset 112. With an A2DP link, data packets including audio may be transmitted over an ACL data channel, and other information, for example, for controlling the audio stream, may be transmitted over a separate control channel. The data packets may occur non-periodically.

In another aspect, the communications link 116 may support synchronous logical transport mechanisms between a source device (such as the central device 102) and a peripheral device (such as the headset 112). For example, the communications link 116 may include a synchronous connection-oriented (SCO) link that provides a symmetric point-to-point link between the source device and the peripheral device using time slots reserved for BT communications. In some aspects, an SCO link may not support retransmission of data packets, which may be unsatisfactory in audio streaming and/or voice use cases in which a dropped audio or voice packet may reduce the quality of the user experience.

In a further aspect, the communications link 116 may include an extended SCO (eSCO) link. An eSCO link may provide a symmetric or asymmetric point-to-point link between a source device and a peripheral device using time slots reserved for BT communications, and may also provide for a retransmission window following the reserved time slots. Because retransmissions may be facilitated using the retransmission window, an eSCO link may be suitable for audio streaming and/or voice use cases because a dropped audio or voice packet may be retransmitted, and therefore the probability of successfully receiving a data packet may be increased.

In one aspect, the communications link 116 may include an Isochronous (ISO) link. When operating as an ISO link, the communications link 116 may combine some features of both synchronous and asynchronous links. For example, a stream on an ISO link may begin with a start packet, and then data packets may be asynchronously transmitted. On an ISO link, the number of retransmission attempts by a transmitting device may be limited. Thus, if a receiving device is unable to decode a data packet within the limited number of retransmission attempts, then the data packet may be dropped and the receiving device may continue to receive the stream without data from the dropped data packet.

As described in more detail elsewhere herein, the Bluetooth Controller 252 (or a WPAN controller) and/or WWAN controller 256 may establish a WPAN low energy (LE) connection with a receiving device, the WPAN LE connection being associated with a first number of transmission occasions for each transmission interval; identify an event associated with one or more of: a number of communications that satisfies a quantity threshold, or one or more communications having a latency requirement that satisfies a latency threshold; and transmit, to the receiving device and based at least in part on identifying the event, an indication to communicate using a more data (MD) mode, the MD mode being associated with a second number of transmission occasions for each transmission interval, the second number being greater than the first number. Additionally, or alternatively, the Bluetooth Controller 252 may perform one or more other operations described herein.

In some aspects, the wireless communication device includes means for establishing a WPAN LE connection with a receiving device, the WPAN LE connection being associated with a first number of transmission occasions for each transmission interval; means for identifying an event associated with one or more of: a number of communications that satisfies a quantity threshold, or one or more communications having a latency requirement that satisfies a latency threshold; and/or means for transmitting, to the receiving device and based at least in part on identifying the event, an indication to communicate using a MD mode, the MD mode being associated with a second number of transmission occasions for each transmission interval, the second number being greater than the first number. In some aspects, the means for the wireless communication device to perform operations described herein may include, for example, one or more of Bluetooth controller 252, WWAN controller 256.

As indicated above, FIG. 2 is provided as an example. Other examples may differ from what is described with regard to FIG. 2.

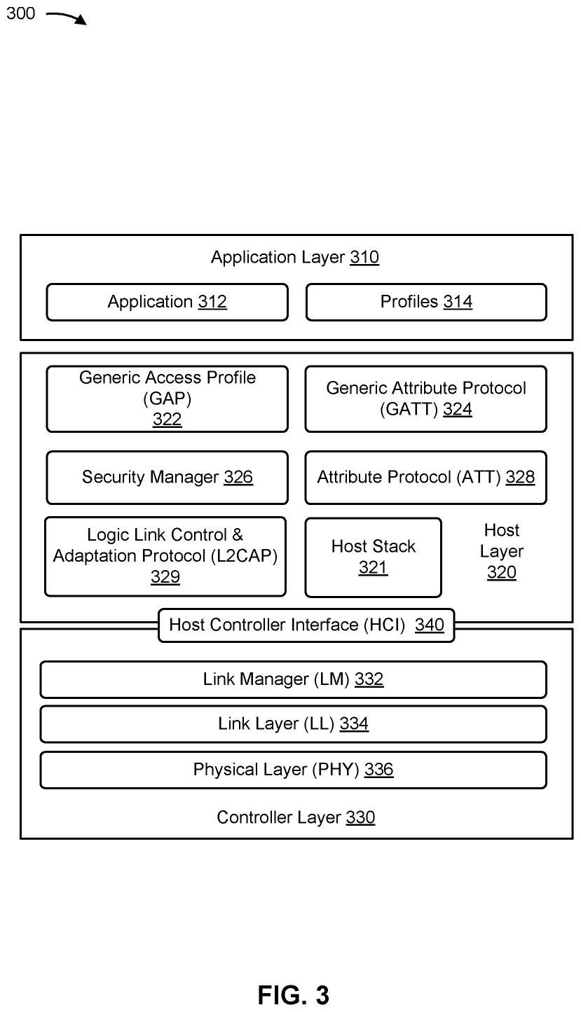

FIG. 3 is a diagram illustrating an example 300 of a protocol stack (e.g., a WPAN and/or a Bluetooth protocol stack), in accordance with the present disclosure. The protocol stack 300 may be implemented in a wireless communication device (such as the central device 102 or one or more of the peripheral devices 104, 106, 108, 110, or 112 of FIG. 1). For example, the BT protocol stack 300 may be implemented by one or more of processor(s) 202, memory 206, Flash memory 210, ROM 208, the radio 230, and/or the Bluetooth controller 252 illustrated in FIG. 2. The BT protocol stack 300 may be organized into three layers including Application layer 310, a Host layer 320, and a Controller layer 330.

The Application layer 310 may be a user application that interfaces with the other blocks and/or layers of the BT protocol stack 300. In some aspects, the Application layer 310 may include one or more applications 312 and one or more Bluetooth profiles 314 that allow the applications to use the Bluetooth and BLE communications. The Host layer 320 may include the upper layers of the BT protocol stack 300, and may communicate with a controller (such as the Bluetooth controller 252 of FIG. 2) in a wireless communication device using a Host Controller Interface (HCI) 340. In some aspects, the Host layer 320 may include a host stack 321 that can be used for application layer interface management to allow an application to access Bluetooth communications.

The Controller layer 330 may include the lower layers of the BT protocol stack 300. The Controller layer 330, which may be used for hardware interface management, link establishment, and link management, is shown to include a Link Manager (LM) 332, a Link Layer (LL) 334, and a physical (PHY) layer 336. The PHY layer 336 may include, for example, a radio and/or a baseband processor. In some aspects, the PHY layer 336 may define the mechanism for transmitting a bit stream over a physical link or channel that connects BT devices. The bit stream may be grouped into code words or symbols, and converted to a data packet that is transmitted over a wireless transmission medium. The PHY layer 336 may provide an electrical, mechanical, and/or procedural interface to the wireless transmission medium. The PHY layer 336 may be responsible for modulation and demodulation of data into radio frequency (RF) signals for transmission over the air. The PHY layer 336 may describe the physical characteristics of a wireless communication device's receiver/transmitter. The physical characteristics may include modulation characteristics, radio frequency tolerance, sensitivity level, etc.

The Link Layer 334 is responsible for low-level communication over the PHY layer 336. The Link Layer 334 334 manages the sequence and timing for transmitting and receiving data packets, and using a LL protocol, communicates with other devices regarding connection parameters and data flow control. The Link Layer 334 also provides gatekeeping functionality to limit exposure and data exchange with other devices. If filtering is configured, the Link Layer 334 maintains a list of allowed devices and will ignore all requests for data exchange from devices not on the list. The Link Layer 334 may also reduce power consumption. In some aspects, the Link Layer 334 may include a company's proprietary LL that may be used to discover peer devices, and establish a secure communication channel therewith. In certain aspects, the Link Layer 334 may be responsible for transporting data packets between devices in a WPAN. Each data packet may include an access address, which specifies the type of logical transport used to carry the data packet. Logical transports may exist between a master device and slave devices. Additionally, some logical transports may carry multiple logical links.

The Link Manager 332 may be responsible for establishing and configuring links and managing power-change requests, among other tasks. Each type of logical link, such as ACL links, A2DP links, SCO links, eSCO links, ISO links, etc., may be associated with a specific packet type. For example, an SCO link may provide reserved channel bandwidth for communication between a master device and a slave device, and support regular, periodic exchange of data packets with no retransmissions. An eSCO link may provide reserved channel bandwidth for communication between a source device and a peripheral device, and support regular, periodic exchange of data packets with retransmissions. An ACL link may exist between a source device and a peripheral device from the beginning of establishment of a connection between the source device and the peripheral device, and the data packets for ACL links may include encoding information in addition to a payload.

The Link Manager 332 may communicate with the Host layer 320 using the HCI 340. In some instances, the Link Manager 332 may translate HCI 340 commands into controller-level operations, such as baseband-level operations. The HCI 340 may act as a boundary between the lower layers (such as between the Controller layer 330, the Host layer 320, and the Application layer 310). The BT specification may define a standard HCI to support BT systems that are implemented across two separate processors. For example, a BT system on a computer may use the BT system's own processor to implement the lower layers of the BT protocol stack 300, such as the PHY layer 336, the Link Layer 334, and/or the Link Manager 332. In some aspects, the BT system may use a processor of a BT component to implement the other layers of the BT protocol stack 300 such as, for example, the Host layer 320 and the Application layer 310.

The Host layer 320 is shown to include a Generic Access Profile (GAP) 322, a Generic attribute Protocol (GATT) 324, a Security Manager (SM) 326, Attribute Protocol (ATT) 328, and a L2CAP layer 329. The GAP 322 may provide an interface for the application 312 to initiate, establish, and manage connections with other BT or BLE devices. The GATT 324 may provide a service framework using the attribute protocol for discovering services, and for reading and writing characteristic values on a peer device. The GATT 324 may interface with the application 312, for example, through a profile which may define a collection of attributes and any permission needed for the attributes to be used in BT or BLE communications.

The Security Manager 326 may be responsible for device pairing and key distribution. A security manager protocol implemented by the Security Manager 326 may define how communications with the Security Manager of a counterpart BLE device are performed. The Security Manager 326 provides additional cryptographic functions that may be used by other components of the BT protocol stack 300. The architecture of the Security Manager 326 used in Bluetooth communications is designed to minimize recourse requirements for peripheral devices by shifting work to an assumingly more powerful central device. BLE uses a pairing mechanism for key distribution. The Security Manager 326 provides a mechanism to not only encrypt the data but also to provide data authentication.

The ATT 328 includes a client/server protocol based on attributes associated with a BLE device configured for a particular purpose. Examples may include monitoring heart rate, temperature, broadcasting advertisements, etc. The attributes may be discovered, read, and written by peer devices. The set of operations which are executed over ATT 328 may include, but are not limited to, error handling, server configuration, find information, read operations, write operations, queued writes, etc. The ATT 328 may form the basis of data exchange between BT and BLE devices.

The L2CAP layer 329 may be implemented above the HCI 340, and may communicate with the controller layer 330 through the HCI 340. The L2CAP layer 329 may be primarily responsible for establishing connections across one or more existing logical links and for requesting additional links if none exist. The L2CAP layer 329 may also implement multiplexing between different higher-layer protocols, for example, to allow different applications to use a single link, such as a logical link, including an ACL link. In some implementations, the L2CAP layer 329 may encapsulate multiple protocols from the upper layers into a data packet format (and vice versa). The L2CAP layer 329 may also break packets with a large data payload from the upper layers into multiple packets with the data payload segmented into smaller size data payloads that fit into a maximum payload size (for example, twenty-seven bytes) on the transmit side.

In some standards and protocols, such as BLE and/or BR/EDR, the central device 102 may detect errors in a packet and/or a dropped/missed/not received packet through the use of cyclic redundancy check (CRC) validation and through the use of message integrity code (MIC) validation. MIC validation may be used when a packet is encrypted. For example, failure of CRC validation may indicate one or more errors in a received packet and failure of MIC validation may indicate that another packet has not been received (although failure of CRC validation may also indicate another packet has not been received and/or failure of MIC validation may also indicate one or more errors in a received packet).

CRC validation and MIC validation may be based on generating CRC values and MICs, respectively, based on received packets and respectively comparing those generated CRC values and MICs to CRC and MICs included in received packets. Specifically, a receiving device, such as the headset 112, that receives a packet may first generate a CRC value or a CRC checksum based on the received packet, such as based on a payload and, if applicable, a MIC included in the received packet. The receiving device may compare the generated CRC value with a CRC value included in the received packet. If the generated CRC value matches the CRC value included in the received packet, then the received packet may be validated for CRC. The CRC-validated received packet may then be decrypted. However, if the generated CRC value does not match the CRC value included in the received packet, then the receiving device may determine that the received packet fails CRC validation. If the receiving device determines the received packet fails CRC validation, then the received packet may include errors and/or may be corrupted. In one configuration, the receiving device may discard the received packet that fails CRC validation; however, in another configuration, the receiving device may attempt to recover the received packet, for example, using one or more error correction techniques.

If the received packet is encrypted and passes CRC validation, then the receiving device may decrypt the received packet to obtain a decrypted payload and a decrypted MIC. For MIC validation, the receiving device may generate a MIC based on the decrypted payload, and compare the generated MIC with the MIC obtained from the decrypted received packet. If the generated MIC matches the decrypted MIC, then the receiving device may determine that the received packet is successfully decrypted. When the received packet is successfully decrypted, the decoded and decrypted payload of the received packet may be provided to another layer of the receiving device, such as a coder-decoder (codec) of the receiving device that may cause the payload data of the received packet to be output by the receiving device, for example, as audio through speakers of the headset 112.

If the generated MIC does not match the decrypted MIC of the received packet, then the receiving device may determine that the received packet is unsuccessfully decrypted. When the received packet is unsuccessfully decrypted, then a different packet may have been missed or the received packet may be erroneous or otherwise corrupted. In one configuration, the receiving device may discard the received packet that fails MIC validation; however, in another configuration, the receiving device may attempt to recover the received packet.

As indicated above, FIG. 3 is provided as an example. Other examples may differ from what is described with regard to FIG. 3.

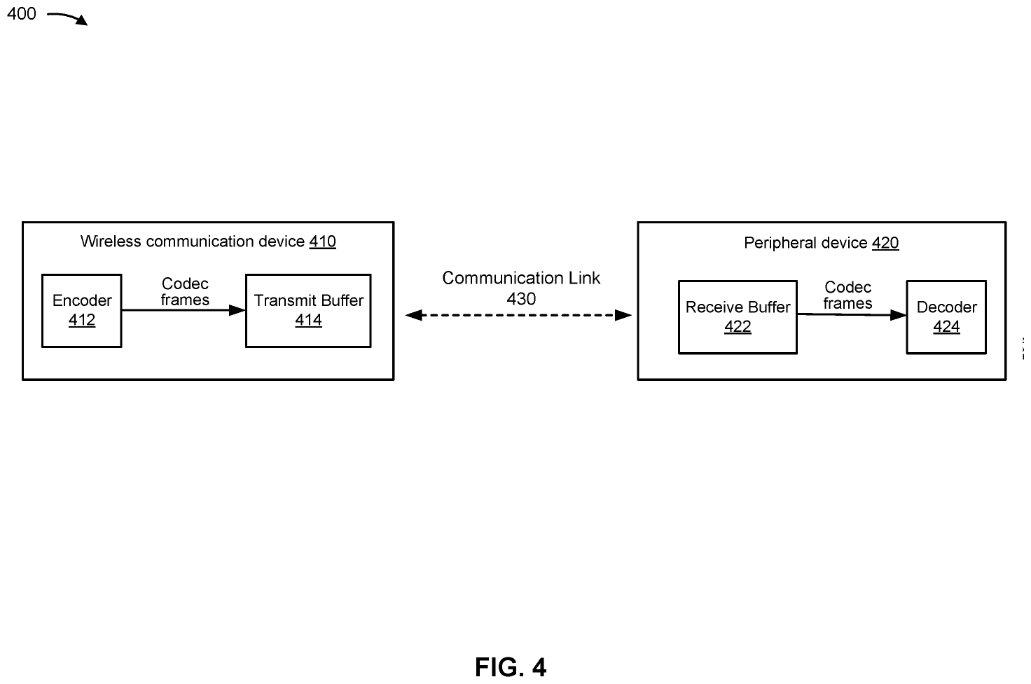

FIG. 4 depicts an example transmission 400 of data packets from a wireless communication device 410 to a peripheral device 420 over a communication link 430, according to various aspects of the present disclosure. In some implementations, the wireless communication device 410 may be one example of the central device 102 of FIG. 1, or the wireless communication device 200 of FIG. 2, and the peripheral device 420 may be an example of one or more of the peripheral devices 104, 106, 108, 110, 112 or 114 of FIG. 1. In some instances, the peripheral device 420 may be a pair of earbuds. The communication link 430 may be any suitable Bluetooth connection or link. In some instances, the communication link 430 may be one or more of an asynchronous connection-less (ACL) link, a Logical Link Control and Adaptation Protocol (L2CAP) link, an Advanced Audio Distribution Profile (A2DP) link, a synchronous connection-oriented (SCO) link, or an isochronous (ISO) link.

The wireless communication device 410 is shown to includer an encoder 412 and a transmit buffer 414. The encoder 412 may be configured to encode data, such as audio or video data, using a specified bitrate. The transmit buffer 414 may be configured to queue data packets that are to be transmitted over the communication link 430 to the peripheral device 420. In some implementations, the data packets to be transmitted over the communication link 430 may be of a predefined size, for example, based on the type of communication link 430 and/or channel conditions associated with the communication link 430. In some aspects, data encoded by the encoder 412 may be packetized into a data packet of a predefined size. The wireless communication device 410 may de-queue data packets from the transmit buffer 414 and transmit the data packets to the peripheral device 420 over the communication link 430.

The peripheral device 420 is shown to includer a receive buffer 422 and a decoder 424. Data packets received over the communication link 430 may be queued or otherwise stored in the receive buffer 422. The data packets may be output from the receive buffer 422 and forwarded to the decoder 424. In some aspects, the decoder 424 may decode data (such as audio and/or video data) carried in the payloads of the queued data packets, and forward the decoded data to upper layers of the protocol stack for processing and playback to a user. In some implementations, the encoder 412 may encode a first encoder/decoder (codec) frame using a first bitrate, and forward the first codec frame to the transmit buffer 414 to be packetized for transmission to the peripheral device 420 over the communication link 430. The peripheral device 420 may queue the received data packet in the receive buffer 422, and may forward the first portion of the first codec frame to the decoder 424 for decoding.

As indicated above, FIG. 4 is provided as an example. Other examples may differ from what is described with regard to FIG. 4.

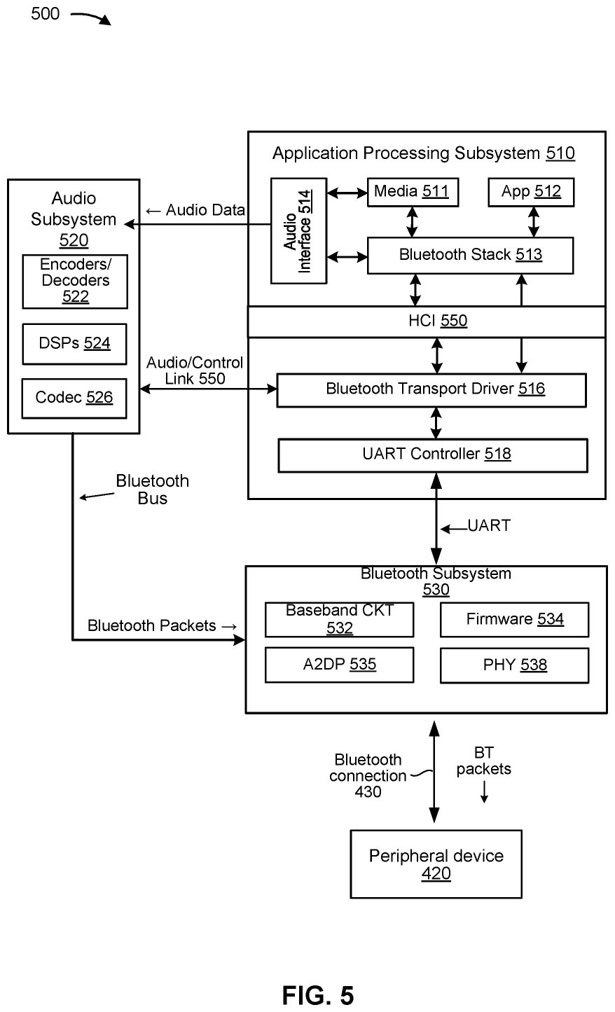

FIG. 5 shows a block diagram of another example wireless communication device 500, according to various aspects of the present disclosure. In some implementations, the wireless communication device 500 may be an example of the central device 102 of FIG. 1, the wireless communication device 200 of FIG. 2, or the wireless communication device 410 of FIG. 4. In the example of FIG. 5, the wireless communication device 500 is depicted as having an established communication link 430 (e.g., a Bluetooth communication connection) with the peripheral device 420 of FIG. 4.

The wireless communication device 500 may include an Application Processing subsystem 510, an audio subsystem 520, a Bluetooth subsystem 530, and a Host Controller Interface (HCI) 550. The Application Processing subsystem 510, which may correspond to at least some portions of the application layer 310 and the Host layer 320 of the BT protocol stack 300 of FIG. 3, is shown to include a media player 511, an Application Layer (App) 512, a Bluetooth stack 513, and an audio interface 514. The media player 511 can be suitable device or component capable of generating or receiving multimedia content including, for example, real-time audio streams, real-time video streams, real-time gaming streams, and other latency-sensitive traffic. The App 512, which may be one implementation of the Application layer 310 FIG. 3, includes at least one Bluetooth profile that defines the collection of attributes and associated permissions to be used in Bluetooth or BLE communications. In some aspects, the App 512 may include processing resources including (but not limited to) the memory 206, the ROM 208, and the Flash memory 210 of FIG. 2. The Bluetooth stack 513 may be one implementation of the BT protocol stack 300 of FIG. 3.

The Bluetooth transport driver 516 may include a split audio and packetization module (not shown for simplicity) that can packetize data (such as audio and/or video data) into Bluetooth frames that can be transmitted to the peripheral device 420 using either a Bluetooth or BLE protocol.

The Bluetooth transport driver 516 is connected to the audio subsystem 520 via an audio and control link 560. In some instances, the audio and control link 560 may be used to send encoded audio/video data and control signals between the Bluetooth transport driver 516 and audio/video DSPs within the audio subsystem 520.

The Bluetooth transport driver 516 is connected to a universal asynchronous receiver-transmitter (UART) controller 518 that provides controls for transmission of information via a Bluetooth connection.

The audio subsystem 520 may include encoders/decoders 522, one or more digital signal processors (DSPs) 524, and one or more codecs 526. The encoders/decoders 522 may be used to sample audio/video data extracted from one or more packets received from another wireless communication device. The extracted audio/video data may be processed in the Application Processing Subsystem 510 based at least in part on the Bluetooth profile. In some implementations, the encoders/decoders 522 may partition the sampled audio/video data into payloads that can be embedded within one or more Bluetooth packets for transmission to the peripheral device 420 over a Bluetooth or BLE connection. In some instances, the DSPs 524 and/or the codecs 526 may employ one or more encoding or decoding algorithms in conjunction with sampling the audio data.

The Bluetooth subsystem 530 may include a baseband circuit (CKT) 532 (e.g., Bluetooth baseband circuit), Bluetooth firmware 534, an advanced audio distribution profile (A2DP) circuit 536, and a PHY 538. The baseband circuit 532 and the Bluetooth firmware 534 may be used to generate baseband signals for constructing and deconstructing data frames based on the Bluetooth or BLE protocol. The baseband circuit 532 and the Bluetooth firmware 534 may also be used to generate carrier signals for up-converting baseband signals during data transmissions and for down-converting received data signals to baseband. The A2DP circuit 536 may be used to control or manage an A2DP link between the wireless communication device 500 and the peripheral device 420. Specifically, when the Bluetooth subsystem 530 is in a receive mode, the PHY 538 can be used to receive, demodulate, and down-convert data packets received over the communication link 430, and to forward the data packets to the Application Processing subsystem 510. When the Bluetooth subsystem 530 is in a transmit mode, the PHY 538 can be used to encapsulate data provided from the upper layers into one or more Bluetooth frames or packets for transmission to the peripheral device 420 over the communication link 430.

As indicated above, FIG. 5 is provided as an example. Other examples may differ from what is described with regard to FIG. 5.

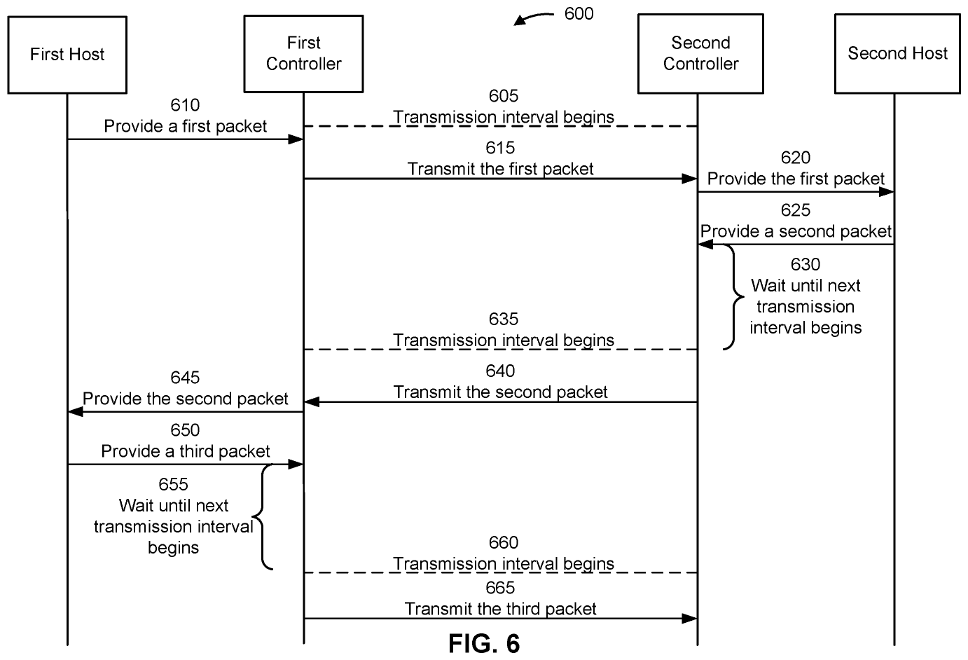

FIG. 6 is a diagram illustrating an example 600 of communication via a WPAN LE connection, in accordance with the present disclosure.

As shown in FIG. 6, a first host, a first controller, a second host, and a second controller may be in communication. For example, the first host may be in communication with the first controller (e.g., in a single wireless communication device), the first controller may be in communication with the second controller (e.g., over the air using a WPAN LE connection), and the second controller may be in communication with the second host. The first host (e.g., an application) may be in communication with the second host (e.g., an application) via the first controller and the second controller. For example, the first host may generate information to transmit to the second host, the first host may provide the information to the first controller for generating signaling for transmission of the information to the second controller, and the second controller may decode the signaling to generate the information to provide to the second host.

As shown by reference number 605, a transmission interval (e.g., Event 1) begins. The transmission interval may be associated with a window of time during which one or more transmissions may take place. In some networks (e.g., in a WPAN LE connection), a limited number of messages (e.g., only one message) may be transmitted during the transmission interval when in a default configuration. A connection between the first controller and the second controller may be in a default configuration based at least in part on an allocation of one message being expected to be sufficient based at least in part on an amount of data buffered for transmission between the first controller and the second controller.

In some networks, a message may be sent during a transmission interval only if the message arrives at a controller before the transmission interval begins or within a window after the transmission interval begins.

As shown by reference number 610, the first host may provide a first packet to the first controller for transmission to the second controller. The first packet may be associated with a request for a response from the second controller, a process that includes an exchange of several messages, an initial setup of the connection between the first host and the second host, and/or a set of low-latency messages (e.g., messages having a latency requirement that satisfies a threshold), among other examples.

As shown by reference number 615, the first controller may transmit, and the second controller may receive, the first packet. For example, the first controller may transmit the first packet using a BLE and/or WPAN LE connection with the second controller.

As shown by reference number 620, the second controller may provide the first packet to the second host. The second controller may process the first packet before providing the first packet to the second host. For example, the second controller may demodulate and decode the first packet as received from the first controller before providing the first packet to the second host.

As shown by reference number 625, the second host may provide a second packet to the second controller for transmission to the first controller and the first host. The second packet may be a low-latency packet and/or a packet of a set of several packets to be exchanged between the first host and the second host, among other examples.

As shown by reference number 630, the second controller waits until a next transmission interval begins. For example, the second controller may need to wait until the next transmission interval begins based at least in part on receiving the second packet after the transmission interval described in connection with reference number 605 began or after an associated window expired.

As shown by reference number 635, a transmission interval (e.g., Event 2) begins (e.g., a next transmission interval begins).

As shown by reference number 640, the second controller may transmit, and the first controller may receive, the second packet. As shown by reference number 645, the first controller may provide the second packet to the first host. In some networks, the second packet may have a latency requirement that failed to be satisfied based at least in part on waiting until after the transmission interval described in connection with reference number 635 began.

As shown by reference number 650, the first host may provide a third packet to the first controller for transmission to the second controller and the second host. The third packet may be a low-latency packet and/or a packet of a set of several packets to be exchanged between the first host and the second host, among other examples. Additionally, or alternatively, the third packet may be generated based at least in part on the second packet and/or based at least in part on an arrival time of the second packet failing to satisfy a latency requirement.

As shown by reference number 655, the first controller waits until a next transmission interval begins. For example, the first controller may need to wait until the next transmission interval begins based at least in part on receiving the third packet after the transmission interval described in connection with reference number 635 began or after an associated window expired.

As shown by reference number 660, a transmission interval (e.g., Event 3) begins (e.g., a next transmission interval begins).

As shown by reference number 665, the first controller may transmit, and the second controller may receive, the third packet. In some networks, the second packet may have a latency requirement that failed to be satisfied based at least in part on waiting until after the transmission interval described in connection with reference number 635 began.

As indicated above, FIG. 6 is provided as an example. Other examples may differ from what is described with regard to FIG. 6.

As described herein, for Bluetooth LE and/or WPAN LE procedures, wireless communication devices may exchange data within transmission intervals. Once an exchange timing of a transmission interval has passed, wireless communication devices may be required to wait until a subsequent transmission interval to transmit additional data or other packets. In some cases, arrival times of packets do not align with the exchange timing of transmission intervals, so packets are delayed as the wireless communication devices wait until subsequent transmission intervals.

In an example, a wireless communication device (e.g., a device that includes the first host and the first controller of FIG. 6) receives input to provide data (e.g., music) to a receiving device (e.g., a device that includes the second controller and the second host of FIG. 6). Before the receiving device can receive the data and/or present information associated with the data (e.g., play the music), procedures may need to be performed. For example, the wireless communication device and the receiving device may need to establish a logical connection (e.g., an audio logical connection), perform a codec configuration procedure, perform a quality of service (QOS) configuration procedure, and/or an audio enabling procedure, among other examples. These procedures may cause delay to performance of the receiving device and may negatively affect a user experience.

In a BLE and/or WPAN protocol, after entering a connected state, wireless communication devices and receiving devices (e.g., peripheral devices) may schedule transmission and reception at a point in time (e.g., an anchor point) with a configured interval length (e.g., periodicity). In some networks, the interval length may be relatively long to increase power saving. Alternatively, the interval length may be relatively short to increase transmit and receive opportunities.

In a communication example, a packet is originated at a host and uncertain delay is added to arrival of the packet at the controller based at least in part on waiting until a subsequent transmission interval. For example, a majority of packets may miss an anchor point and will be delayed until the subsequent transmission interval. In this case, two consecutive packets received at the controller of a transmitting wireless communication device may be separated in time by the interval length (e.g., based at least in part on the transmission interval allowing only one transmission per transmission interval).

In some networks, a communication protocol may support a MD mode that allows an increased number of transmissions in a transmission interval. For example, if packets are already in the controller of the transmitting wireless communication device, the controller may set a communication mode to MD mode to indicate that additional transmissions will be presented in the transmission interval.

However, if the packets have not arrived at the controller of the transmitting wireless communication device, the controller may be unaware of additional packets to support with MD mode, and/or may be unaware of timing of receiving the additional packets. Additionally, or alternatively, if the additional packets are from a remote device (e.g., a device that does not include the controller), the controller will be unable to predict whether there will be additional packets coming soon, as the controller is not informed of a host-level procedure associated with the additional packets. For this reason, the controller will not use the MD mode when the controller does not already have the additional packets before a transmission interval begins. In this way, the WPAN LE configuration may conserve power, communication, computing, and/or network resources, but will result in delays and communication errors (e.g., associated with failures to satisfy latency requirements).

In some aspects described herein, a wireless communication device and a receiving device may establish a WPAN LE (e.g., a BLE) connection. The WPAN LE connection is associated with a first number of transmission occasions for each transmission interval (e.g., one transmission per transmission interval). The wireless communication device may identify an event associated with an expected need to enable an MD mode. For example, the wireless communication device may identify an event associated with a number of communications that satisfies a quantity threshold, or one or more communications having a latency requirement that satisfies a latency threshold. The wireless communication device may transmit to the receiving device, based at least in part on identifying the event, an indication to communicate using the MD mode. The MD mode is associated with a second number of transmission occasions for each transmission interval, with the second number being greater than the first number.

In some aspects, procedures may have a predefined set of packets to exchange. This means that the host may determine a beginning, ending, and/or number of packets of a procedure. If the controller is made aware of an on-going procedure with packets that are expected to arrive during a transmission interval, the controller may enable MD. In this way, the packets may be transmitted upon arrival at the controller rather than being delayed until a subsequent transmission interval.

In an example, after an LE link is establish, the wireless communication device and the receiving device may need to exchange several messages (e.g., logical link control protocol (LLCP) messages and/or profile data). Based at least in part on being aware of the several messages to be exchanged after establishing an LE link, the wireless communication device (e.g., the controller) may enable MD mode (e.g., for a configured amount of time after establishing the LE link) to support exchanging the several messages.

In another example, based at least in part on receiving input at a user interface of the wireless communication device (e.g., a command to send a data feed to the receiving device, such as audio or video streams, among other examples), the wireless communication device may determine if the input is associated with an exchange of a number of packets that is not supported in a default mode. Based at least in part on the input being associated with an exchange of the number of packets that is not supported in the default mode, the wireless communication device (e.g., the host) may provide an indication to use the MD mode (e.g., to the controller). The wireless communication device may also provide an indication to disable MD mode based at least in part on receiving an additional input or after a process or application is finished. In some aspects, the wireless communication device the host may provide the indications as a vendor command.

In another example, the wireless communication device (e.g., the controller or the host) may identify important and/or time-sensitive messages associated with a procedure (e.g., an LE audio connection). Based at least in part on the procedure being associated with important and/or time-sensitive messages, the wireless communication device may enable MD mode to reduce an amount of time needed to complete the procedure.

Based at least in part on the wireless communication device initiating an MD mode of an LE connection based at least in part on an anticipated need for the MD mode (e.g., rather than based only on whether multiple data packets are already buffered for transmission before a transmission interval), the wireless communication device may reduce delays in communications via the LE connection. For example, the wireless communication device may support satisfaction of a latency requirement of a communication, may reduce an amount of time needed to complete a multi-message process, and/or may reduce errors in the communication caused by delays.

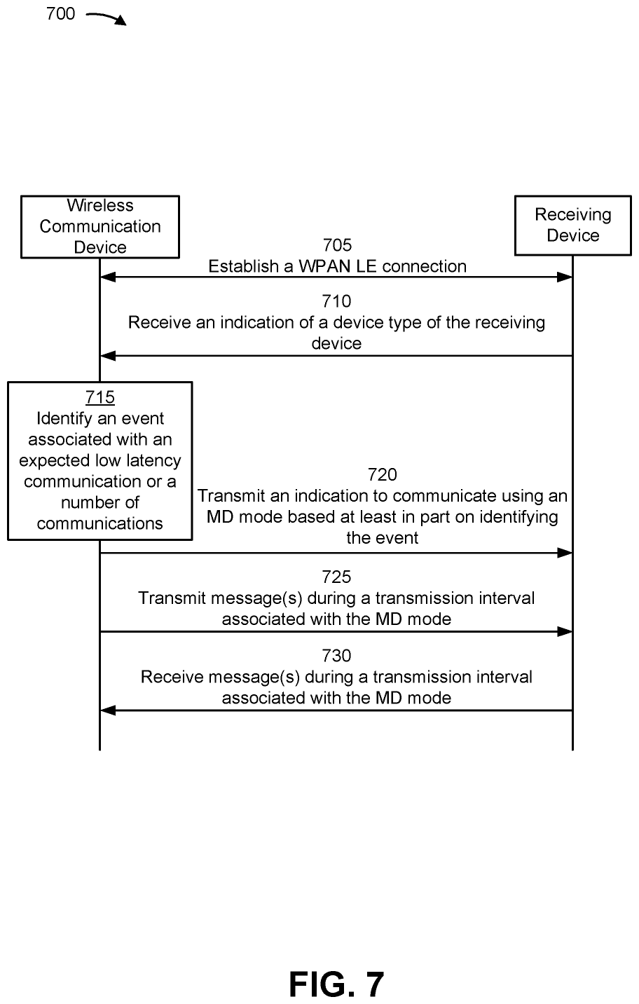

FIG. 7 is a diagram of an example 700 associated with event-based initiation of a more data mode for a WPAN LE connection, in accordance with the present disclosure. As shown in FIG. 7, wireless communication device (e.g., central device 102, wireless communication device 200, and/or wireless communication device 410, among other examples) may communicate with a receiving device (e.g., peripheral devices 104, 106, 108, 110, or 112, wireless communication device 200, wireless communication device 410, and/or peripheral device 420). In some aspects, the wireless communication device and the receiving device may be part of a wireless network (e.g., WPAN 100).

As shown by reference number 705, the wireless communication device and the receiving device may establish a WPAN LE connection. For example, the wireless communication device and/or the receiving device may exchange a set of messages to indicate an availability for a connection (e.g., a pairing request, a security message, and/or a handshake, among other examples).

In some aspects, the WPAN LE connection may have a default mode having a first number of transmission occasions for each transmission interval. For example, the first number of transmission occasions may be one.

As shown by reference number 710, the wireless communication device may receive, and the receiving device may transmit, an indication of a device type of the receiving device. For example, the wireless communication device may receive the indication of the device type as part of establishing the WPAN LE connection or as a separate message. The receiving device may be a media device (e.g., an audio device or a video device) that provides an output for the wireless communication device.

As shown by reference number 715, the wireless communication device may identify an event associated with an expected low latency communication or a number of communications. For example, the event may include establishment of the WPAN LE connection, an initiation of a procedure associated with a number of communications that satisfies a quantity threshold, and/or a set of communications having a latency requirement that satisfies a latency threshold (e.g., having a low-latency requirement), among other examples.

In some aspects, the event is associated with an indication received via a user interface (UI) of the wireless communication device. In some aspects, the event is associated with an indication from an application host of the wireless communication device to a controller of the wireless communication device.

In some aspects, the wireless communication device may transmit the indication to communicate using the MD mode based at least in part on a device type of the receiving device. For example, the wireless communication device may indicate to use the MD mode based at least in part on identifying an event for some device types, but may not indicate to use the MD mode for other device types. In an example, the wireless communication device may indicate to use the MD mode based at least in part on identifying an establishment of the WPAN LE connection and based at least in part on the receiving device being a media device, such as a video or audio device that outputs a data stream from the wireless communication device.

In some aspects, an application host of the wireless communication device may identify the event. The application host may indicate identification of the event, a request to enable MD mode, and/or one or more parameters for the MD mode (e.g., a length of time and/or a number of messages expected to be exchanged during the MD mode). In some aspects, a controller may identify the event independently from the application host of the wireless communication device.

As shown by reference number 720, the wireless communication device may transmit, and the receiving device may receive, an indication to communicate using an MD mode based at least in part on identifying the event. In some aspects, the wireless communication device may transmit the indication via an LLCP communication. In some aspects, the wireless communication device may transmit a data packet with the indication of the wireless communication device. In some aspects, the wireless communication device may transmit an empty packet with the indication of the wireless communication device (e.g., if the packet has not yet arrived, but that wireless communication device is enabling MD mode for the transmission interval).

In some aspects, the wireless communication device may transmit the indication to communicate using the MD mode without first receiving multiple packets for transmission during the transmission interval. For example, a number of packets ready for transmission by the wireless communication device at a time of transmitting the indication to communicate using the MD mode may not justify enabling the MD mode (e.g., based at least in part on a default mode being sufficient to handle the traffic of the number of packets). However, the wireless communication device may enable the MD mode even though the number of packets ready for transmission does not justify enabling the MD mode based at least in part on an anticipated number of packets to be ready for transmission during the transmission interval. For example, the wireless communication device may anticipate the anticipated number of packets based at least in part on identifying the event described in connection with reference number 715.

In some aspects, the MD mode may be associated with a second number of transmission occasions for each transmission interval, with the second number of transmissions being greater than the first number of transmissions (e.g., associated with a default mode).

As shown by reference number 725, the wireless communication device may transmit, and the receiving device may receive, one or more messages during the transmission interval associated with the MD mode. In some aspects, the wireless communication device may continue transmitting data packets or empty packets periodically during the transmission interval to keep the MD mode enabled. In some aspects, after completion of the event and/or a process associated with the event described in connection with reference number 715, the wireless communication device may transmit a message to indicate disabling the MD mode.

As shown by reference number 730, the wireless communication device may receive, and the receiving device may transmit, one or more messages during the transmission interval associated with the MD mode. In some aspects, the wireless communication device and the receiving device may interweave communications during the transmission interval, where the wireless communication device transmits one or more packets, then the receiving device transmits one or more packets, then the wireless communication device transmits one or more packets, etc.

In some aspects, the MD mode may have a duration that is based at least in part on an event type of the event (e.g., with the event type associated with a configured duration and/or number of messages), an information element within the indication that indicates the duration, and/or an indication within a communication protocol associated with the WPAN LE connection.

Based at least in part on the wireless communication device initiating an MD mode of an LE connection based at least in part on an anticipated need for the MD mode (e.g., rather than based only on whether multiple data packets are already buffered for transmission before a transmission interval), the wireless communication device may reduce delays in communications via the LE connection. For example, the wireless communication device may support satisfaction of a latency requirement of a communication, may reduce an amount of time needed to complete a multi-message process, and/or may reduce errors in the communication caused by delays.

As indicated above, FIG. 7 is provided as an example. Other examples may differ from what is described with respect to FIG. 7.

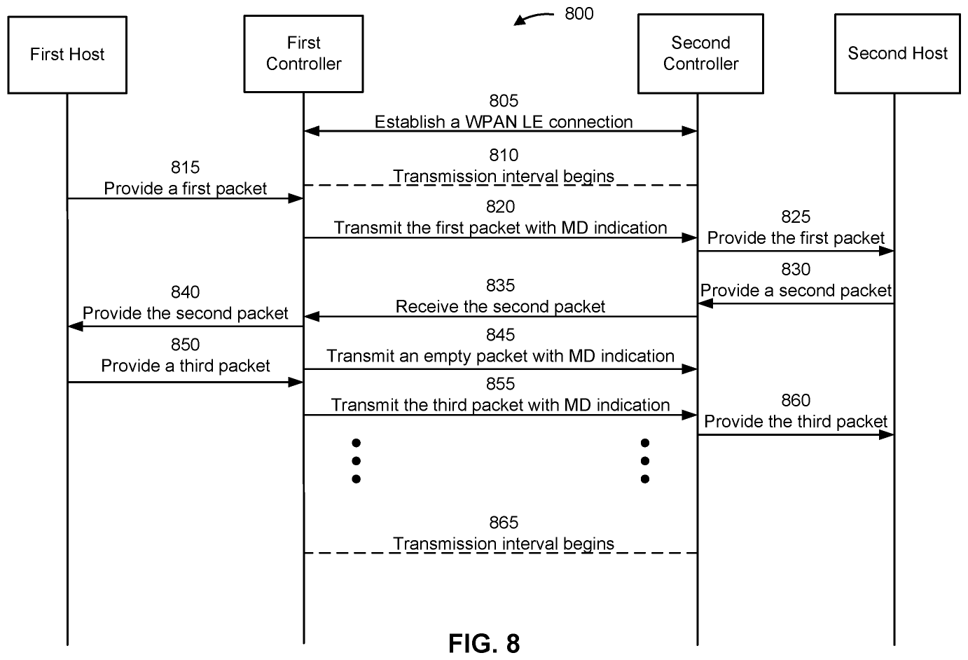

FIG. 8 is a diagram illustrating an example 800 associated with event-based initiation of a more data mode for a WPAN LE connection, in accordance with the present disclosure.

As shown in FIG. 8, a first host, a first controller, a second host, and a second controller may be in communication. For example, the first host may be in communication with the first controller (e.g., in a single wireless communication device), the first controller may be in communication with the second controller (e.g., over the air using a WPAN LE connection), and the second controller may be in communication with the second host. The first host (e.g., an application) may be in communication with the second host (e.g., an application) via the first controller and the second controller. For example, the first host may generate information to transmit to the second host, the first host may provide the information to the first controller for generating signaling for transmission of the information to the second controller, and the second controller may decode the signaling to generate the information to provide to the second host. In some aspects, the first host and the first controller are part of the central device 102 of FIG. 1, or the wireless communication device 200 of FIG. 2. In some aspects, the second host and the second controller are part of the peripheral devices 104, 106, 108, 110, 112 or 114 of FIG. 1 and/or the wireless communication device 200 of FIG. 2.

As shown by reference number 805, the first controller and the second controller may establish a WPAN LE connection. For example, the first controller and/or the second controller may exchange a set of messages to indicate an availability for a connection (e.g., a pairing request, a security message, and/or a handshake, among other examples).

As shown by reference number 810, a transmission interval (e.g., Event 1) begins. The transmission interval may be associated with a window of time during which one or more transmissions may take place. In some aspects (e.g., in a WPAN LE connection), a limited number of messages (e.g., only one message) may be transmitted during the transmission interval when in a default configuration.

In some networks, a message may be sent during a transmission interval of the WPAN LE connection only if the message arrives at a controller before the transmission interval begins or within a window after the transmission interval begins.

As shown by reference number 815, the first host may provide a first packet to the first controller for transmission to the second controller. The first packet may be associated with a request for a response from the second controller, a process that includes an exchange of several messages, an initial setup of the connection between the first host and the second host, and/or a set of low-latency messages (e.g., messages having a latency requirement that satisfies a threshold), among other examples.

As shown by reference number 820, the first controller may transmit, and the second controller may receive, the first packet with an MD indication (e.g., an indication to initiate an MD mode). For example, the first controller may transmit the first packet using a BLE and/or WPAN LE connection with the second controller. The first controller may transmit the first packet with the MD indication based at least in part on being within a time window from establishing the WPAN LE connection.

Based at least in part on receiving the MD indication, the second controller may be configured for communication in the MD mode. For example, the second controller may be configured to not wait for a next transmission interval to transmit additional communications.

As shown by reference number 825, the second controller may provide the first packet to the second host. The second controller may process the first packet before providing the first packet to the second host. For example, the second controller may demodulate and decode the first packet as received from the first controller before providing the first packet to the second host.

As shown by reference number 830, the second host may provide a second packet to the second controller for transmission to the first controller and the first host. The second packet may be a low-latency packet and/or a packet of a set of several packets to be exchanged between the first host and the second host, among other examples. In some aspects, the second packet is associated with an initial exchange of information between the first host and the second host and/or between the first controller and the second controller.

As shown by reference number 835, the second controller may transmit, and the first controller may receive, the second packet. In some aspects, the second controller does not need to wait until a next transmission interval begins based at least in part on the MD mode being enabled.

As shown by reference number 840, the first controller may provide the second packet to the first host. In some networks, the second packet may have a latency requirement that is satisfied based at least in part on not waiting until after a subsequent transmission interval begins.

As shown by reference number 845, the first controller may transmit an empty packet with the MD indication. In some aspects, the first controller may transmit the empty packet with the MD indication based at least in part on a requirement to transmit the MD indication with a minimum frequency to avoid to remain in the MD mode. In some aspects, the second controller may discard the empty packet, rather than providing the empty packet to the second host based at least in part the packet being an empty packet.

As shown by reference number 850, the first host may provide a third packet to the first controller for transmission to the second controller and the second host. The third packet may be a low-latency packet and/or a packet of a set of several packets to be exchanged between the first host and the second host, among other examples. Additionally, or alternatively, the third packet may be generated based at least in part on the second packet. In some aspects, the third packet is associated with an initial exchange of information between the first host and the second host and/or between the first controller and the second controller.

As shown by reference number 855, the first controller may transmit, and the second controller may receive, the third packet with the MD indication. In some networks, the second packet may have a latency requirement that is satisfied based at least in part on not waiting until after a next transmission interval.

As shown by reference number 860, the second controller may provide the third packet to the second host. In some aspects, the first controller and the second controller may continue exchanging messages and/or packets until expiration of a time window after establishing the WPAN LE connection. In some aspects, the first controller and the second controller may continue exchanging messages and/or packets until failing to indicate the MD mode in a message from the first controller.

As shown by reference number 865, a transmission interval (e.g., Event 2) begins. The transmission interval may be associated with a window of time during which one or more transmissions may take place. In some aspects (e.g., in a WPAN LE connection), a limited number of messages (e.g., only one message) may be transmitted during the transmission interval when in a default configuration.

As indicated above, FIG. 8 is provided as an example. Other examples may differ from what is described with regard to FIG. 8.

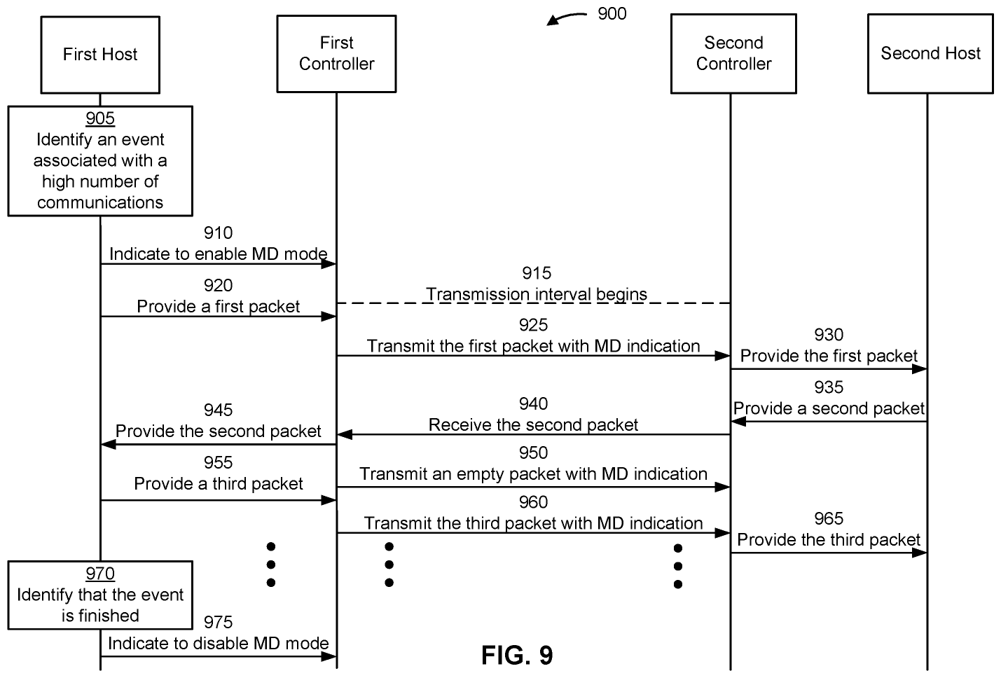

FIG. 9 is a diagram illustrating an example 900 associated with event-based initiation of a more data mode for a WPAN LE connection, in accordance with the present disclosure.

As shown in FIG. 9, a first host, a first controller, a second host, and a second controller may be in communication. For example, the first host may be in communication with the first controller (e.g., in a single wireless communication device), the first controller may be in communication with the second controller (e.g., over the air using a WPAN LE connection), and the second controller may be in communication with the second host. The first host (e.g., an application host) may be in communication with the second host (e.g., an application) via the first controller and the second controller. For example, the first host may generate information to transmit to the second host, the first host may provide the information to the first controller for generating signaling for transmission of the information to the second controller, and the second controller may decode the signaling to generate the information to provide to the second host. In some aspects, the first host and the first controller are part of the central device 102 of FIG. 1, or the wireless communication device 200 of FIG. 2. In some aspects, the second host and the second controller are part of the peripheral devices 104, 106, 108, 110, 112 or 114 of FIG. 1 and/or the wireless communication device 200 of FIG. 2.

As shown by reference number 905, the first host may identify an event associated with a high number of communications. In some aspects, the first host may identify an event during which the first host expects to exchange a number of communications and/or packets that is too high to be served using a default mode of the WPAN LE connection. For example, the event may be associated with an input via a UI of a wireless communication device that includes the first host and/or the first controller, with the input being associated with communications between the first controller and the second controller. In some aspects, the input may trigger an increase in a number of communications between the first host and the second host.

As shown by reference number 910, the first host may indicate, to the first controller, to enable MD mode for communications with the second controller and/or second host. In some aspects, the indication may indicate one or more parameters (e.g., a duration in time and/or a number of messages to maintain the MD mode).

As shown by reference number 915, a transmission interval (e.g., Event 1) begins. The transmission interval may be associated with a window of time during which one or more transmissions may take place. In some aspects (e.g., in a WPAN LE connection), a number of messages (e.g., multiple messages) may be transmitted during the transmission interval when in an MD mode.

As shown by reference number 920, the first host may provide a first packet to the first controller for transmission to the second controller. The first packet may be associated with a request for a response from the second controller, a process that includes an exchange of several messages, an initial setup of the connection between the first host and the second host, and/or a set of low-latency messages (e.g., messages having a latency requirement that satisfies a threshold), among other examples. In some aspects, the first packet may be a first packet of a set of multiple packets associated with the event.

As shown by reference number 925, the first controller may transmit, and the second controller may receive, the first packet with an MD indication (e.g., an indication to initiate an MD mode). For example, the first controller may transmit the first packet using a BLE and/or WPAN LE connection with the second controller. The first controller may transmit the first packet with the MD indication based at least in part on being within a time window from establishing the WPAN LE connection.

Based at least in part on receiving the MD indication, the second controller may be configured for communication in the MD mode. For example, the second controller may be configured to not wait for a next transmission interval to transmit additional communications.

As shown by reference number 930, the second controller may provide the first packet to the second host. The second controller may process the first packet before providing the first packet to the second host. For example, the second controller may demodulate and decode the first packet as received from the first controller before providing the first packet to the second host.

As shown by reference number 935, the second host may provide a second packet to the second controller for transmission to the first controller and the first host. The second packet may be a low-latency packet and/or a packet of a set of several packets to be exchanged between the first host and the second host, among other examples. In some aspects, the second packet is associated with an initial exchange of information between the first host and the second host and/or between the first controller and the second controller.

As shown by reference number 940, the second controller may transmit, and the first controller may receive, the second packet. In some aspects, the second controller does not need to wait until a next transmission interval begins based at least in part on the MD mode being enabled.

As shown by reference number 945, the first controller may provide the second packet to the first host. In some networks, the second packet may have a latency requirement that is satisfied based at least in part on not waiting until after a subsequent transmission interval begins.

As shown by reference number 950, the first controller may transmit an empty packet with the MD indication. In some aspects, the first controller may transmit the empty packet with the MD indication based at least in part on a requirement to transmit the MD indication with a minimum frequency to avoid to remain in the MD mode. In some aspects, the second controller may discard the empty packet, rather than providing the empty packet to the second host based at least in part the packet being an empty packet.

As shown by reference number 955, the first host may provide a third packet to the first controller for transmission to the second controller and the second host. The third packet may be a low-latency packet and/or a packet of a set of several packets to be exchanged between the first host and the second host, among other examples. Additionally, or alternatively, the third packet may be generated based at least in part on the second packet.

As shown by reference number 960, the first controller may transmit, and the second controller may receive, the third packet with the MD indication. As shown by reference number 965, the second controller may provide the third packet to the second host.

In some aspects, the first controller and the second controller may continue exchanging messages and/or packets until, as shown by reference number 970, the first identifies that the event is finished. For example, the first host may determine that the procedure is completed and/or that an application has been closed, among other examples.

As shown by reference number 975, the first host may indicate to the first controller to disable the MD mode. For example, the first host may indicate to disable the MD mode based at least in part on identifying that the event is finished. In some aspects, the first controller may transmit an indication, to the second controller, to disable the MD mode. Alternatively, the first controller may transmit a next communication without the MD indication. Based at least in part on receiving an indication to disable the MD more or receiving a next communication without the MD indication, the second controller may be configured to cease communicating in the MD mode and/or may return to a default mode of the LE connection.

As indicated above, FIG. 9 is provided as an example. Other examples may differ from what is described with regard to FIG. 9.

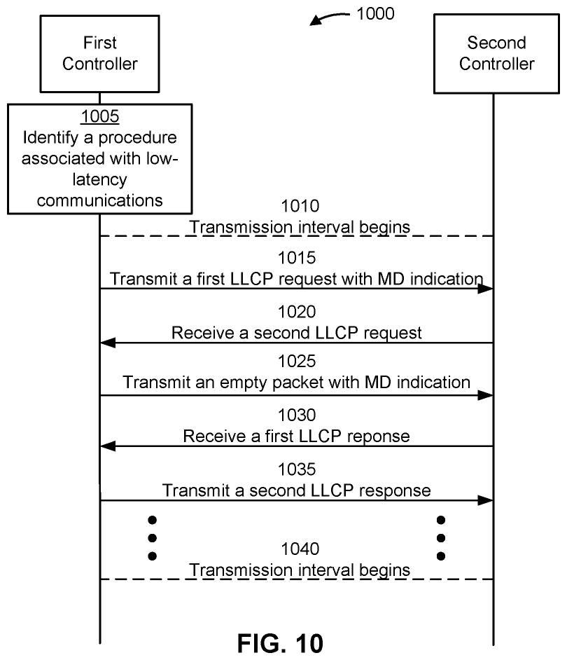

FIG. 10 is a diagram illustrating an example 1000 associated with event-based initiation of a more data mode for a WPAN LE connection, in accordance with the present disclosure.

As shown in FIG. 10, a first controller, a second controller may be in communication. For example, the first controller may be in communication with the second controller via an over the air connection using a WPAN LE connection.

As shown by reference number 1005, the first host may identify a procedure associated with low-latency communications and/or a high number of communications. For example, the procedure may be associated with an exchange of configuration information and/or control messages (e.g., LLCP messages). The procedure may be associated with a low-latency communication associated with establishing an application layer connection (e.g., initiating a media stream from the first controller and the second controller). In some aspects, the first controller is part of the central device 102 of FIG. 1, or the wireless communication device 200 of FIG. 2. In some aspects, the second controller is part of the peripheral devices 104, 106, 108, 110, 112 or 114 of FIG. 1 and/or the wireless communication device 200 of FIG. 2.

As shown by reference number 1010, a transmission interval (e.g., Event 1) begins. The transmission interval may be associated with a window of time during which one or more transmissions may take place. In some aspects (e.g., in a WPAN LE connection), a number of messages (e.g., a single message when in a default mode) may be transmitted during the transmission interval.

As shown by reference number 1015, the first controller may transmit, and the second controller may receive, a first LLCP request with an MD indication (e.g., an indication to initiate an MD mode). For example, the first controller may transmit the first LLCP request using a BLE and/or WPAN LE connection with the second controller. The first controller may transmit the first LLCP request with the MD indication based at least in part on identifying the procedure associated with the low-latency communications. In some aspects, the first controller may transmit the first LLCP request with the MD indication without first having subsequent messages buffered for transmission.

Based at least in part on receiving the MD indication, the second controller may be configured for communication in the MD mode. For example, the second controller may be configured to not wait for a next transmission interval to transmit additional communications.

As shown by reference number 1020, the second controller may transmit, and the first controller may receive, a second LLCP request. In some aspects, the second controller does not need to wait until a next transmission interval begins based at least in part on the MD mode being enabled.

As shown by reference number 1025, the first controller may transmit an empty packet with the MD indication. In some aspects, the first controller may transmit the empty packet with the MD indication based at least in part on a requirement to transmit the MD indication with a minimum frequency to avoid to remain in the MD mode. In some aspects, the second controller may discard the empty packet, rather than providing the empty packet to the second host based at least in part the packet being an empty packet.

As shown by reference number 1030, the first controller may receive, and the second controller may transmit, a first LLCP response associated with the first LLCP request. In some aspects, the second controller does not need to wait until a next transmission interval begins based at least in part on the MD mode being enabled.

As shown by reference number 1035, the first controller may transmit, and the second controller may receive, a second LLCP response associated with the second LLCP request. In some aspects, the first controller does not need to wait until a next transmission interval begins based at least in part on the MD mode being enabled. In some aspects, the second LLCP response may include an MD indication.

In some aspects, the first controller and the second controller may continue exchanging messages and/or packets in an MD mode until, as shown by reference number 1040, a transmission interval begins (e.g., a next transmission interval). In some aspects, the first controller and the second controller may continue exchanging messages and/or packets in an MD mode until the first controller transmits a packet without an MD indication.

As indicated above, FIG. 10 is provided as an example. Other examples may differ from what is described with regard to FIG. 10.

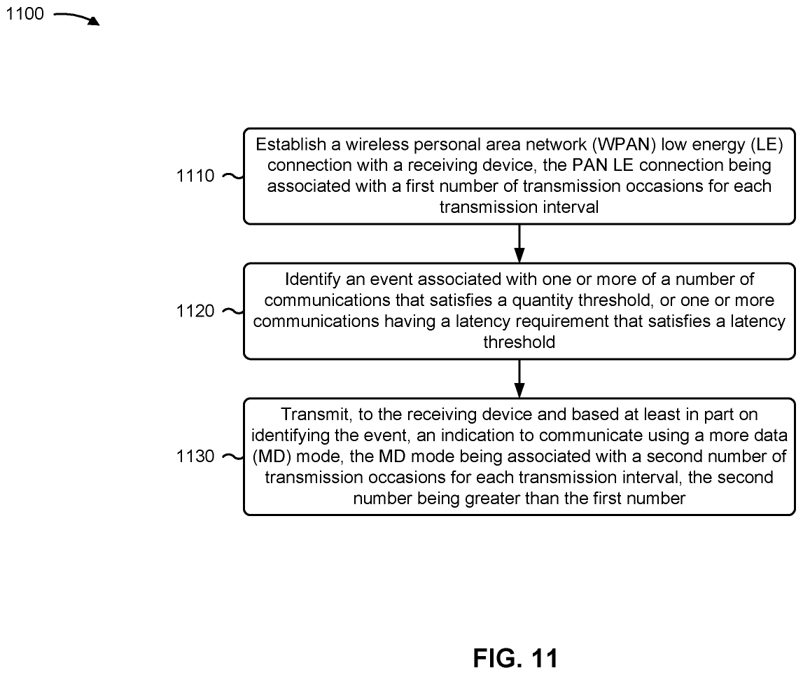

FIG. 11 is a diagram illustrating an example process 1100 performed, for example, by a wireless communication device, in accordance with the present disclosure. Example process 1100 is an example where the wireless communication device (e.g., central device 102, wireless communication device 200, and/or wireless communication device 410, among other examples)) performs operations associated with event-based initiation of an MD mode for a WPAN LE connection.

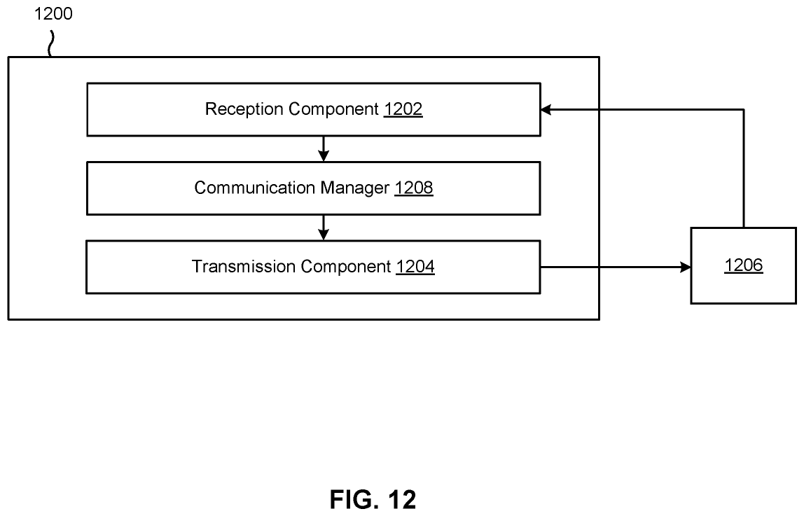

As shown in FIG. 11, in some aspects, process 1100 may include establishing a WPAN LE connection with a receiving device, the WPAN LE connection being associated with a first number of transmission occasions for each transmission interval (block 1110). For example, the wireless communication device (e.g., using a Bluetooth Controller 252, a WPAN controller, and/or a WWAN controller 256 and/or communication manager 1208, depicted in FIG. 12) may establish a WPAN LE connection with a receiving device, the WPAN LE connection being associated with a first number of transmission occasions for each transmission interval, as described above.

As further shown in FIG. 11, in some aspects, process 1100 may include identifying an event associated with one or more of: a number of communications that satisfies a quantity threshold, or one or more communications having a latency requirement that satisfies a latency threshold (block 1120). For example, the wireless communication device (e.g., using a Bluetooth Controller 252, a WPAN controller, and/or a WWAN controller 256 and/or communication manager 1208 depicted in FIG. 12) may identify an event associated with one or more of: a number of communications that satisfies a quantity threshold, or one or more communications having a latency requirement that satisfies a latency threshold, as described above.

As further shown in FIG. 11, in some aspects, process 1100 may include transmitting, to the receiving device and based at least in part on identifying the event, an indication to communicate using a MD mode, the MD mode being associated with a second number of transmission occasions for each transmission interval, the second number being greater than the first number (block 1130). For example, the wireless communication device (e.g., using a Bluetooth Controller 252, a WPAN controller, a WWAN controller 256, and/or an antenna 235, and/or transmission component 1204 depicted in FIG. 12) may transmit, to the receiving device and based at least in part on identifying the event, an indication to communicate using a MD mode, the MD mode being associated with a second number of transmission occasions for each transmission interval, the second number being greater than the first number, as described above.

Process 1100 may include additional aspects, such as any single aspect or any combination of aspects described below and/or in connection with one or more other processes described elsewhere herein.

In a first aspect, the event is associated with establishing the WPAN LE connection.

In a second aspect, alone or in combination with the first aspect, the MD mode has a duration that is based at least in part on an event type of the event, an information element within the indication to communicate using the MD mode, or an indication within a communication protocol associated with the WPAN LE connection.

In a third aspect, alone or in combination with one or more of the first and second aspects, the event is associated with one or more of an indication via a UI of the wireless communication device, or an indication from an application host of the wireless communication device to a controller of the wireless communication device.

In a fourth aspect, alone or in combination with one or more of the first through third aspects, transmitting the indication to communicate using the MD mode is based at least in part on a device type of the receiving device.

In a fifth aspect, alone or in combination with one or more of the first through fourth aspects, process 1100 includes communicating, with the receiving device, multiple messages during a transmission interval based at least in part on transmitting the indication to communicate using the MD mode.

In a sixth aspect, alone or in combination with one or more of the first through fifth aspects, communicating the multiple messages comprises transmitting an empty packet during a transmission occasion of the transmission interval, wherein transmission of the empty packet maintains the MD mode for a subsequent transmission occasion of the transmission interval.

In a seventh aspect, alone or in combination with one or more of the first through sixth aspects, transmitting the indication to communicate using the MD mode comprises transmitting the indication via a LLCP communication.

In an eighth aspect, alone or in combination with one or more of the first through seventh aspects, identifying the event comprises identifying the event via an application host of the wireless communication device, or identifying the event via a controller of the wireless communication device.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a wireless communication device, or a wireless communication device may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as peripheral devices 104, 106, 108, 110, or 112, wireless communication device 200, wireless communication device 410, and/or peripheral device 420) using the reception component 1202 and the transmission component 1204. As further shown, the apparatus 1200 may include a communication manager 1208. The communication manager 1208 may include the WWAN controller 256, the Bluetooth controller 252, the processor(s) 202, and/or the MMU 240.

In some aspects, the apparatus 1200 may be configured to perform one or more operations described herein in connection with FIG. 7-10. Additionally, or alternatively, the apparatus 1200 may be configured to perform one or more processes described herein, such as process 1100 of FIG. 11. In some aspects, the apparatus 1200 and/or one or more components shown in FIG. 12 may include one or more components of the wireless communication device described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a receive processor, a controller/processor, a memory, or a combination thereof, of the wireless communication device described in connection with FIG. 2 or 4.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit processor, a controller/processor, a memory, or a combination thereof, of the wireless communication device described in connection with FIG. 2 or 4. In some aspects, the transmission component 1204 may be co-located with the reception component 1202 in a transceiver.

The communication manager 1208 may establish a WPAN LE connection with a receiving device, the WPAN LE connection being associated with a first number of transmission occasions for each transmission interval. The communication manager 1208 may identify an event associated with one or more of a number of communications that satisfies a quantity threshold, or one or more communications having a latency requirement that satisfies a latency threshold. The transmission component 1204 may transmit, to the receiving device and based at least in part on identifying the event, an indication to communicate using a MD mode, the MD mode being associated with a second number of transmission occasions for each transmission interval, the second number being greater than the first number.

The reception component 1202 and/or the transmission component 1204 may communicate, with the receiving device, multiple messages during a transmission interval based at least in part on transmitting the indication to communicate using the MD mode.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a wireless communication device, comprising: establishing a wireless personal area network (WPAN) low energy (LE) connection with a receiving device, the WPAN LE connection being associated with a first number of transmission occasions for each transmission interval; identifying an event associated with one or more of: a number of communications that satisfies a quantity threshold, or one or more communications having a latency requirement that satisfies a latency threshold; and transmitting, to the receiving device and based at least in part on identifying the event, an indication to communicate using a more data (MD) mode, the MD mode being associated with a second number of transmission occasions for each transmission interval, the second number being greater than the first number.

Aspect 2: The method of Aspect 1, wherein the event is associated with establishing the WPAN LE connection.

Aspect 3: The method of any of Aspects 1-2, wherein the MD mode has a duration that is based at least in part on: an event type of the event, an information element within the indication to communicate using the MD mode, or an indication within a communication protocol associated with the WPAN LE connection.

Aspect 4: The method of any of Aspects 1-3, wherein the event is associated with one or more of: an indication via a user interface (UI) of the wireless communication device, or an indication from an application host of the wireless communication device to a controller of the wireless communication device.

Aspect 5: The method of any of Aspects 1-4, wherein transmitting the indication to communicate using the MD mode is based at least in part on a device type of the receiving device.

Aspect 6: The method of any of Aspects 1-5, further comprising: communicating, with the receiving device, multiple messages during a transmission interval based at least in part on transmitting the indication to communicate using the MD mode.

Aspect 7: The method of Aspect 6, wherein communicating the multiple messages comprises: transmitting an empty packet during a transmission occasion of the transmission interval, wherein transmission of the empty packet maintains the MD mode for a subsequent transmission occasion of the transmission interval.

Aspect 8: The method of any of Aspects 1-7, wherein transmitting the indication to communicate using the MD mode comprises: transmitting the indication via a logical link control protocol (LLCP) communication.

Aspect 9: The method of any of Aspects 1-8, wherein identifying the event comprises: identifying the event via an application host of the wireless communication device, or identifying the event via a controller of the wireless communication device.

Aspect 10: An apparatus for wireless communication at a device, comprising a processor; memory coupled with the processor; and instructions stored in the memory and executable by the processor to cause the apparatus to perform the method of one or more of Aspects 1-9.

Aspect 11: A device for wireless communication, comprising a memory and one or more processors coupled to the memory, the one or more processors configured to perform the method of one or more of Aspects 1-9.

Aspect 12: An apparatus for wireless communication, comprising at least one means for performing the method of one or more of Aspects 1-9.

Aspect 13: A non-transitory computer-readable medium storing code for wireless communication, the code comprising instructions executable by a processor to perform the method of one or more of Aspects 1-9.

Aspect 14: A non-transitory computer-readable medium storing a set of instructions for wireless communication, the set of instructions comprising one or more instructions that, when executed by one or more processors of a device, cause the device to perform the method of one or more of Aspects 1-9.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A wireless communication device for wireless communication, comprising:
a memory; and
one or more processors, coupled to the memory, configured to:
establish a wireless personal area network (WPAN) low energy (LE) connection with a receiving device, the WPAN LE connection being associated with a first number of transmission occasions for each transmission interval;
identify an event associated with one or more of:
a number of communications that satisfies a quantity threshold, or
one or more communications having a latency requirement that satisfies a latency threshold; and
transmit, to the receiving device and based at least in part on identifying the event, an indication to communicate using a more data (MD) mode, the MD mode being associated with a second number of transmission occasions for each transmission interval, the second number being greater than the first number.

2. The wireless communication device of claim 1, wherein the event is associated with establishing the WPAN LE connection.

3. The wireless communication device of claim 1, wherein the MD mode has a duration that is based at least in part on:
an event type of the event,
an information element within the indication to communicate using the MD mode, or
an indication within a communication protocol associated with the WPAN LE connection.

4. The wireless communication device of claim 1, wherein the event is associated with one or more of:
an indication via a user interface (UI) of the wireless communication device, or
an indication from an application host of the wireless communication device to a controller of the wireless communication device.

5. The wireless communication device of claim 1, wherein transmitting the indication to communicate using the MD mode is based at least in part on a device type of the receiving device.

6. The wireless communication device of claim 1, wherein the one or more processors are further configured to:
communicate, with the receiving device, multiple messages during a transmission interval based at least in part on transmitting the indication to communicate using the MD mode.

7. The wireless communication device of claim 6, wherein the one or more processors, to communicate the multiple messages, are configured to:
transmit an empty packet during a transmission occasion of the transmission interval,
wherein transmission of the empty packet maintains the MD mode for a subsequent transmission occasion of the transmission interval.

8. The wireless communication device of claim 1, wherein the one or more processors, to transmit the indication to communicate using the MD mode, are configured to:
transmit the indication via a logical link control protocol (LLCP) communication.

9. The wireless communication device of claim 1, wherein the one or more processors, to identify the event, are configured to:
identify the event via an application host of the wireless communication device, or
identify the event via a controller of the wireless communication device.

10. A method of wireless communication performed by a wireless communication device, comprising:
establishing a wireless personal area network (WPAN) low energy (LE) connection with a receiving device, the WPAN LE connection being associated with a first number of transmission occasions for each transmission interval;
identifying an event associated with one or more of:
a number of communications that satisfies a quantity threshold, or one or more communications having a latency requirement that satisfies a latency threshold; and
transmitting, to the receiving device and based at least in part on identifying the event, an indication to communicate using a more data (MD) mode, the MD mode being associated with a second number of transmission occasions for each transmission interval, the second number being greater than the first number.

11. The method of claim 10, wherein the event is associated with establishing the WPAN LE connection.

12. The method of claim 10, wherein the MD mode has a duration that is based at least in part on:
an event type of the event,
an information element within the indication to communicate using the MD mode, or
an indication within a communication protocol associated with the WPAN LE connection.

13. The method of claim 10, wherein the event is associated with one or more of:
an indication via a user interface (UI) of the wireless communication device, or
an indication from an application host of the wireless communication device to a controller of the wireless communication device.

14. The method of claim 10, wherein transmitting the indication to communicate using the MD mode is based at least in part on a device type of the receiving device.

15. The method of claim 10, further comprising:
communicating, with the receiving device, multiple messages during a transmission interval based at least in part on transmitting the indication to communicate using the MD mode.

16. The method of claim 15, wherein communicating the multiple messages comprises:
transmitting an empty packet during a transmission occasion of the transmission interval,
wherein transmission of the empty packet maintains the MD mode for a subsequent transmission occasion of the transmission interval.

17. The method of claim 10, wherein transmitting the indication to communicate using the MD mode comprises:
transmitting the indication via a logical link control protocol (LLCP) communication.

18. The method of claim 10, wherein identifying the event comprises:
identifying the event via an application host of the wireless communication device, or
identifying the event via a controller of the wireless communication device.

19. A non-transitory computer-readable medium storing a set of instructions for wireless communication, the set of instructions comprising:
one or more instructions that, when executed by one or more processors of a wireless communication device, cause the wireless communication device to:
establish a wireless personal area network (WPAN) low energy (LE) connection with a receiving device, the WPAN LE connection being associated with a first number of transmission occasions for each transmission interval;
identify an event associated with one or more of:
a number of communications that satisfies a quantity threshold, or
one or more communications having a latency requirement that satisfies a latency threshold; and
transmit, to the receiving device and based at least in part on identifying the event, an indication to communicate using a more data (MD) mode, the MD mode being associated with a second number of transmission occasions for each transmission interval, the second number being greater than the first number.

20. The non-transitory computer-readable medium of claim 19, wherein the event is associated with establishing the WPAN LE connection.

21. The non-transitory computer-readable medium of claim 19, wherein the MD mode has a duration that is based at least in part on:
an event type of the event,
an information element within the indication to communicate using the MD mode, or
an indication within a communication protocol associated with the WPAN LE connection.

22. The non-transitory computer-readable medium of claim 19, wherein the event is associated with one or more of:
an indication via a user interface (UI) of the wireless communication device, or
an indication from an application host of the wireless communication device to a controller of the wireless communication device.

23. The non-transitory computer-readable medium of claim 19, wherein transmitting the indication to communicate using the MD mode is based at least in part on a device type of the receiving device.

24. The non-transitory computer-readable medium of claim 19, wherein the one or more instructions further cause the wireless communication device to:
communicate, with the receiving device, multiple messages during a transmission interval based at least in part on transmitting the indication to communicate using the MD mode.

25. An apparatus for wireless communication, comprising:
means for establishing a wireless personal area network (WPAN) low energy (LE) connection with a receiving device, the WPAN LE connection being associated with a first number of transmission occasions for each transmission interval;
means for identifying an event associated with one or more of:
a number of communications that satisfies a quantity threshold, or
one or more communications having a latency requirement that satisfies a latency threshold; and
means for transmitting, to the receiving device and based at least in part on identifying the event, an indication to communicate using a more data (MD) mode, the MD mode being associated with a second number of transmission occasions for each transmission interval, the second number being greater than the first number.

26. The apparatus of claim 25, wherein the event is associated with establishing the WPAN LE connection.

27. The apparatus of claim 25, wherein the MD mode has a duration that is based at least in part on:
an event type of the event,
an information element within the indication to communicate using the MD mode, or
an indication within a communication protocol associated with the WPAN LE connection.

28. The apparatus of claim 25, wherein the event is associated with one or more of:
an indication via a user interface (UI) of the apparatus, or
an indication from an application host of the apparatus to a controller of the apparatus.

29. The apparatus of claim 25, wherein transmitting the indication to communicate using the MD mode is based at least in part on a device type of the receiving device.

30. The apparatus of claim 25, further comprising:
means for communicating, with the receiving device, multiple messages during a transmission interval based at least in part on transmitting the indication to communicate using the MD mode.
